(19) United States
(12) Patent Application Publication
(10) Pub. No.: US 2007/0136694 A1
(43) Pub. Date: Jun. 14, 2007

(54) Color and context-adaptable hardware button

(75) Inventors: Jonathan D. Friedman, Seattle, WA (US); Christian J. Colando, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/298,760

(22) Filed: Dec. 9, 2005

(51) Int. Cl. G06F 9/00

(52) U.S. Cl. 715/840

(57) ABSTRACT

Described is changing the perceived appearance of a switch by writing content (e.g., an icon) to a switch assembly to change the context of the switch based upon a hardware device's current operating context and/or by changing the perceived color of the switch based upon the hardware device's current operating context. The switch may be layered, for example, with a transparent cover associated with a light guide that can change color via a controlled LED, a writeable surface and an underlying switch (e.g., physical or capacitive sensed) mechanism. Upon detecting interaction with a user interface, the appearance of a switch is based on a current context of the user interface. The system includes means for writing to the writeable surface so that it corresponds to the current context of the program.

### BACKGROUND

Hardware buttons are useful for quickly navigating to important or common user interface features of a hardware device. The hardware devices may be fixed, such as an automated teller machine (ATM) or an interactive screen at a grocery store. Other devices are hand-held and mobile, such as mobile telephones, personal digital assistants (PDA) and the like. Some hardware devices are designed for one-handed interaction with the buttons, so that, for example, a user can interact with the device while driving.

A difficulty in designing hardware buttons for easy and intuitive user interaction is that that the button needs to mapped to a location (and context) that are ever changing. By way of example, some hardware buttons (on phones or ATMs for instance) change their meaning based on the current context of the user interface. These types of hardware buttons are often aligned next to the display so that they can be labeled by the display when their context changes. While such buttons are useful, they still have mapping issues and at times alignment issues (especially in the case of ATMs). It is not unusual for a user to have to hunt for a button for quite some time, and even to select the wrong one.

A related issue is that in an attempt to accommodate all of the functionality that hardware devices can offer, mobile devices end up implementing too many hardware buttons. This results in clutter that detracts from the aesthetics of a device and cheapens the overall look and feel of the device.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards writing content (e.g., an icon) to a switch to change the context of the switch based upon a hardware device's current operating context. Upon detecting interaction with a user interface, the appearance of a switch is based on a current context of the user interface. For example, the perceived color of the switch also may be changed based upon the hardware device's current operating context; the color change may be in conjunction with the writing of the content.

In one implementation, system comprising an assembly includes a writeable region that is associated with a sensor that controls operation of a program running on the computer device. The system includes means for writing to the writeable region in conjunction with the current context of the program.

Other advantages will become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose computing environment into which various aspects of the present invention may be incorporated.

FIG. 2 is a layered representation of a hardware switch including components stacked layered to provide improved user interaction.

FIGS. 3 and 4 comprise representations of simplified example application programs being controlled by a switch that changes visible icons to match the current program context.

FIGS. 5-10 comprise example representations of programs being controlled by a switch that changes visible icons and color to match each current program's current context.

### DETAILED DESCRIPTION

Exemplary Operating Environment

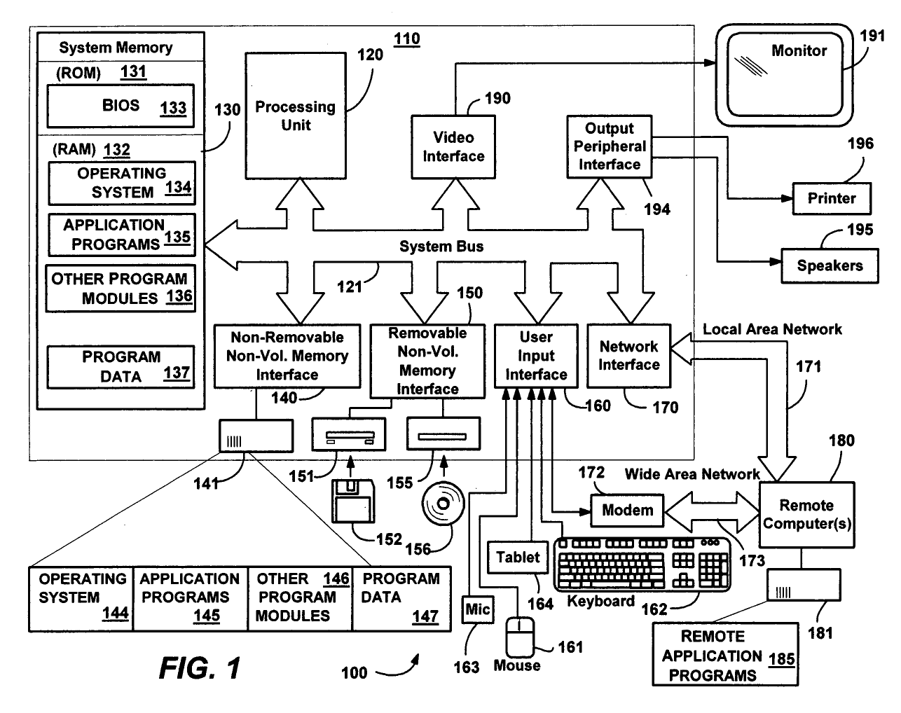

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, described above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Color And Context-Adaptable Hardware Button

Various aspects of the technology described herein are directed towards controlling the appearance and/or context of a hardware button, for example to correspond to the current context of visible user interface output on a display screen. Although the technology described herein describes various ways to accomplish example implementations, the present invention is not limited to any particular examples. As but one example, a type of switch referred to as a D-Pad is described, for its qualities of having five switches, typically configured as four directional switches (for up, down, right and left) movement and one selection switch for entering. However, virtually any type of button/switch including pen or touch sensitive mechanisms, and/or configurations, such as four or so buttons to the right of an ATM screen, a single button used at different times for different results, a keyboard key, a button accompanying or incorporated into an auxiliary display device, and so forth, may benefit from the technology described herein. As such, any of the examples mentioned herein are non-limiting, and the present invention may be used various ways that provide benefits and advantages in computing and switching activities in general.

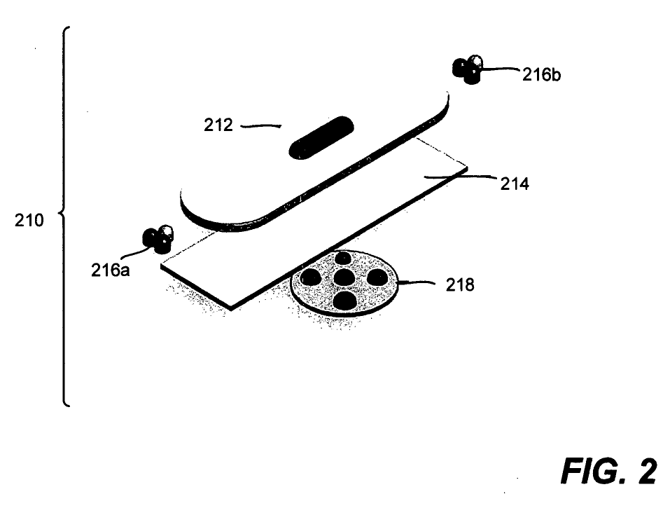

FIG. 2 shows one example implementation including a switch mechanism 210 dissembled for purpose of explanation into stacked layers. A clear (including reasonably transparent/translucent even if not completely clear) switch cover 212 serves as a protective covering, while allowing a user of the switch mechanism 210 to view the contents of an underlying electronic ink display 214.

In one desirable implementation, the switch cover 212 comprises a light guide, incorporates light guide, or is closely coupled to light guide. As is known, a light guide is typically plastic or other mostly transparent material, that contain etched lines or other internal flaws/facets so that light applied to the light guide (e.g., from a front, back and/or side direction) is diffused across the surface, giving the appearance of the switch cover 212 being lit up, rather than appearing as a piece of plastic or glass with having light simply shown through. In general, one or more appropriately-positioned RGB-based LEDs (two are shown labeled 214a and 214b) provide the coloring that illuminates the switch cover 212, although any alterative coloring scheme is equivalent. The diffused light may reflect up or down.

The next lower layer (from the perspective of FIG. 2) comprises an electronic ink display 214. In general, content such as icons, text, animations and essentially anything that can be displayed within the resolution limits may be written to the electronic ink display 214. Various types of such devices are known including black and white matrix types, LCD-based screens and so forth. One such type is a bi-stable electronic ink display 214, which has the benefit of not requiring ongoing power to persist content written to it. Virtually any other type of electronic ink display 214 is feasible. Because of the stacked configuration, images (e.g., crisp black and white or two-color) may appear closely underneath or aside the actual buttons. The images written to the buttons display can change as appropriate for a current context, while a top light LED set (e.g., RGB clusters) can change the color reflected off of other (e.g., white) pixels to match the UI's color and assist in tying the button functionality to certain elements of the user interface.

The bottom layer of the stacked switch mechanism 210 comprises the individual switches, in this example the five-way (D-Pad) comprising individual buttons/switches 218 that convert pressure (typically originating from a human finger) to a signal that indicates which of the five switches is being actuated. Note that the transparent cover/light guide 212 and electronic ink display 214 need to be configured (e.g., to yield and/or rock as necessary) to allow surface pressure to be transferred to the individual buttons.

As can be readily appreciated, a five-way switch is only one example of a mechanism which can facilitate user interaction with a device/program. Any other numbers of switches, combinations, styles, patterns and so forth may benefit from context. Even if a number of buttons are present, they need not all be active in a given context; e.g., left and right can be ignored if in a current user interface context only up, down and select have meaning.

In operation, when coupled to a hardware device such as those described above, including a mobile device (e.g., phone, tablet computer, laptop computer) or fixed device (non-mobile computer, ATM, store checkout display and so forth) the clear switch cover/light guide 212, in conjunction with the electronic ink display 214, provides the ability to write context-based icons that appear below the switch cover. One or more RGB-based LEDs 216 are controllable color to give the entire switch mechanism the appearance of being illuminated, and, for example, may change colors at the same time the context-icons change. As a result, a user receives visible guidance in the form of color and displayed content (e.g., an icon) in conjunction with the user's device interaction. For example, a program context handling means 390 comprising program and/or intermediate (e.g., operating system) code and one or more interfaces control the output.

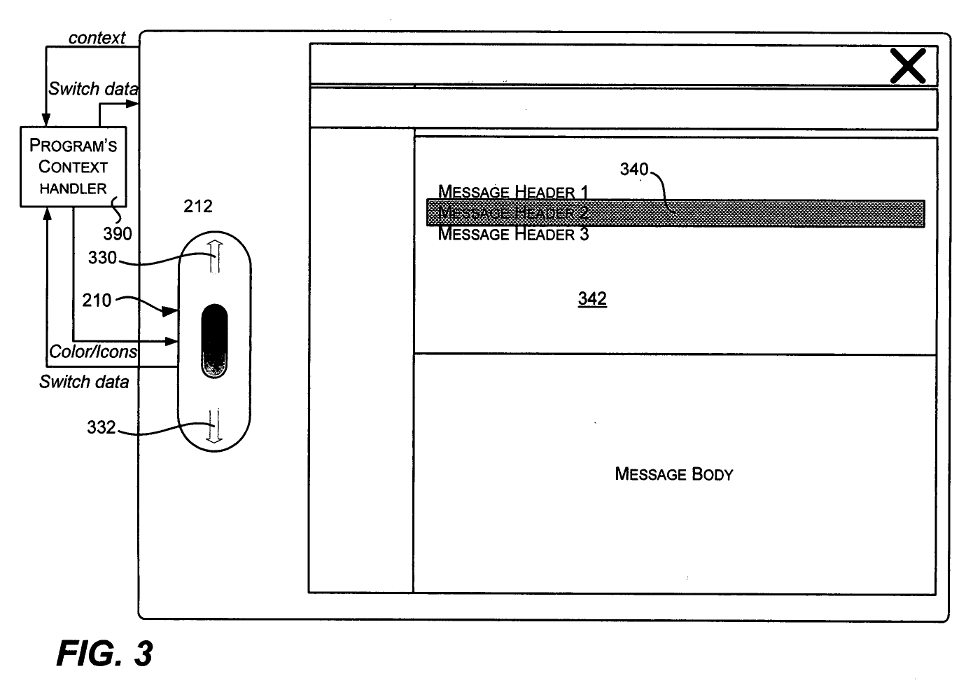

By way of example, consider the switch 210 being illuminated and icons 330 and 332 being presented. The LED's illuminating color (not shown in this black-and-white example, but may be something such as light-blue which may be configured by the user) may be one that matches the program's state and context, which in this simplified example allows a user to use up and down buttons to navigate via a selection bar 340 that highlights a message header among email messages displayed on a user interface 342. In FIG. 3, navigation is intentionally limited in the current context to up, down or select; e.g., actuating the right and left buttons (of a D-Pad) have no affect, nor is anything being shown to the user to suggest anything but up, down and select (always present in the center) are valid.

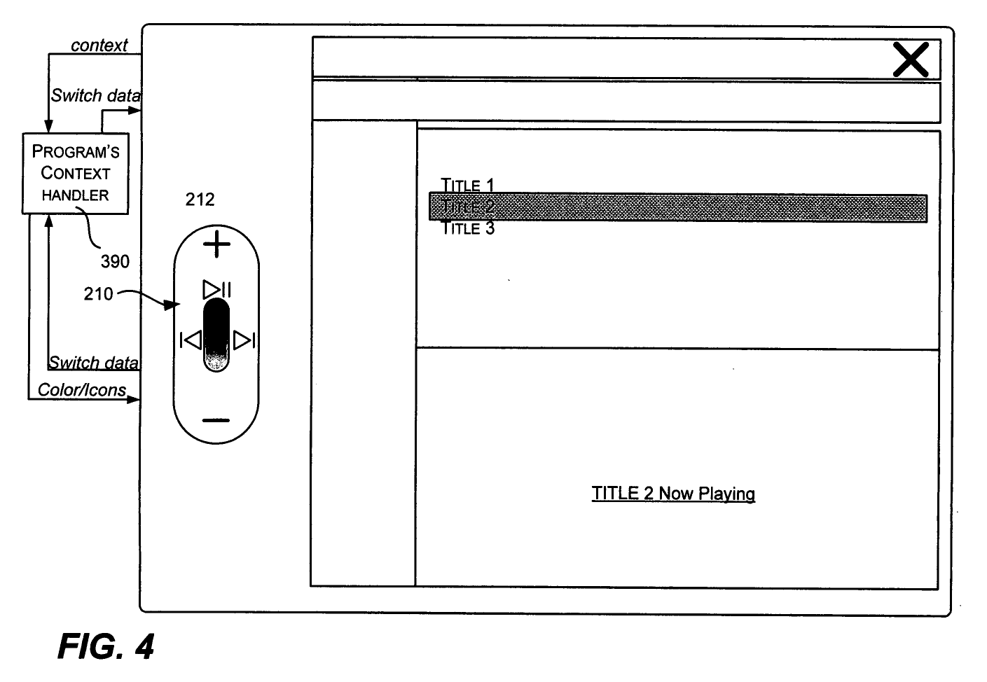

To contrast the example of FIG. 3, using the same switch mechanism 210, different options are available to a user, and thus different colors and icons may be presented. For example, in FIG. 4, the substantially same device that in FIG. 3 was running a mail message-type program is now operating as a media player, as indicated in the program windows. At the same time, the icons have changed to let the user know that the switch is capable of facilitating media play, e.g., volume up and down icons are displayed as plus and minus symbols on the switch 210 (actually rendered on the electronic ink display layer 214), respectively. Also displayed are icons for common media operation, fast forward, rewind and pause. Note that when stopped or paused, the icons can change as appropriate, as even though the media program is the same, its operating context changes when the media is stopped, or paused.

In addition to the above-described combination of a clear switch cover, an RGB color-morphing front light, an electronic ink display and a five-way dome switch, the stacking of technologies also allow the implementation of alternative switching mechanisms. For example a touch panel that acts via a capacitive touch field (with a single physical button) may be present instead of the five physical buttons of an actual switch. Thus, this alternative operates via a capacitive (touch sensitive field) to locate finger placement and a physical press to activate it. Among other possible benefits, in this alternative implementation a larger area of context buttons may appear and disappear, there is no limit to the switch number other than what is practical.

Notwithstanding, in each of these alternatives tactile (often referred to as haptic) feedback is typically desirable to most users. Thus, capacitive sensing may be trigger something the user did not intend or does not even recognized as having occurred.

To this end, the switch may have bumps, depressions, slopes and many other types of mechanical, audible, visible feedback that a user can sense. For example, on a small device, a user may hunt around for a DPAD-type switch without looking, such as when driving or typing.

Further, as the button contains graphics output capabilities, the button is capable of acting as at an auxiliary display, including at times when the main host system is powered down, at least to an extent. For example, instead of having lights such as additional LEDs for notification, things such as the battery level, message received and so forth may be presented to the user via the switch mechanism 210. Further, as described above, the switch mechanism 210 may be of a kind that persists rendered content without consuming power.

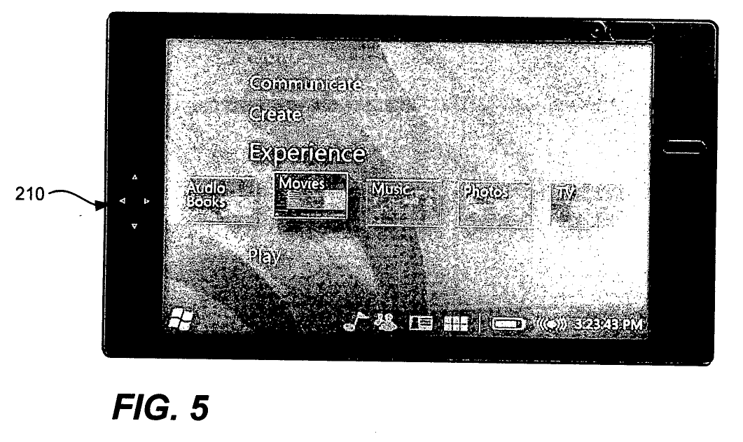

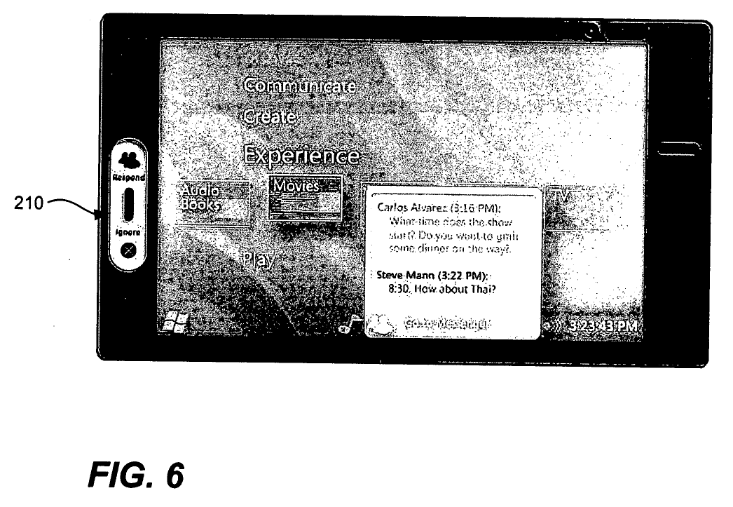

FIGS. 5-6, although in grayscale and not in color, provide additional examples and example scenarios that describe the structure, operation, functionality and the appearance of the context changeable switch. In FIG. 5, the user interface is operating in a program launcher mode where the user can navigate right/left or up/down. The switch mechanism 210 writes black pixels to the whole button, except for the white arrows. The function of the button 210 is thus configured for directional operation and the user given notice with the arrows. In general, the button is illuminated to match the displayed color.

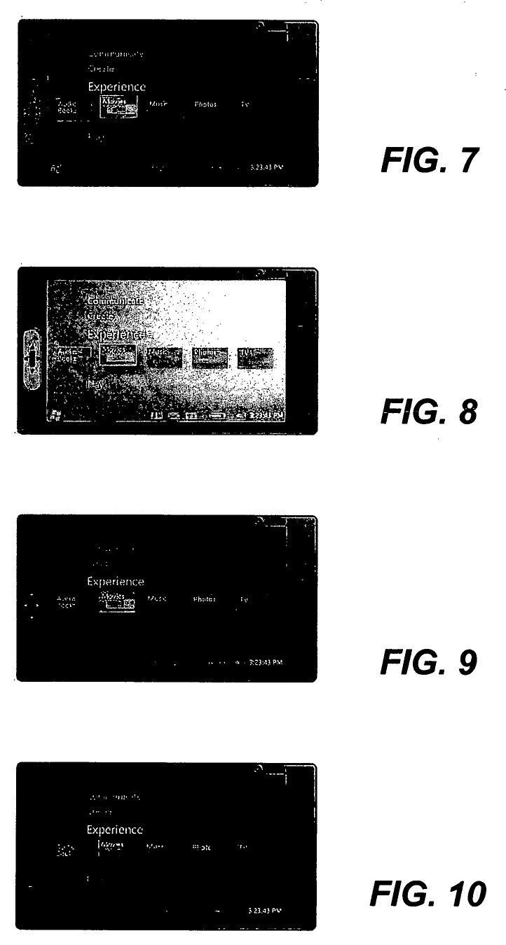

In FIG. 6 there is a change in the device's operating context, namely an email notification has arrived and the UI introduces a notification that someone has sent an instant message. The switch 210 becomes front lighted with a light green color to match the display aesthetic. The icons are updated to reflect the information in context (to accept or ignore), and the top cover is illuminated to match the color of the actual notification to visually tie the two together. If the UI is switched to a different application such as generally represented in the examples of FIGS. 7-10, the context of the button changes (e.g., via preprogramming) to best suit that application.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. At least one computer-readable medium having computer-executable instructions, which when executed perform steps, comprising:
writing content to a switch to change the context of the switch based upon a hardware device's current operating context.

2. The computer-readable medium of claim 1 wherein writing content to the switch comprises outputting an icon to a graphics display of the switch.

3. The computer-readable medium of claim 1 wherein the switch is a multiple-direction switch, and wherein writing content to the switch comprises outputting an icon for each active direction.

4. The computer-readable medium of claim 1 having further computer-executable instructions comprising, changing the perceived color of the switch in conjunction with the writing of the content.

5. The computer-readable medium of claim 4 wherein changing the perceived color of the switch is performed in conjunction with the writing of the content.

6. A system comprising:
an assembly including a writeable region that is associated with a sensor that controls operation of a program; and
means for writing to the writeable region in conjunction with the current context of the program.

7. The system of claim 6 wherein the assembly further includes a cover through which the writeable region may be viewed.

8. The system of claim 7 wherein a perceived color of the cover may be changed, and further comprising, means for changing the perceived color in conjunction with the current context of the program.

9. The system of claim 8 wherein the means for changing the perceived color comprises at least one LED controlled via program context handling means.

10. The system of claim 6 wherein the sensor comprises a physical switch.

11. The system of claim 10 wherein the physical switch comprises a D-PAD type switch.

12. The system of claim 10 wherein the physical switch comprises at least one of: buttons adjacent a display screen, a single button, a keyboard key, and a button accompanying or incorporated into an auxiliary display device.

13. The system of claim 6 wherein the sensor comprises a capacitive sensor.

14. A method comprising:
detecting interaction with a user interface; and
changing the appearance of a switch based on a current context of the user interface.

15. The method of claim 14 wherein changing the appearance of the switch comprises changing the switch color.

16. The method of claim 14 wherein changing the appearance of the switch comprises changing visible content written to the switch.

17. The method of claim 16 wherein changing the visible content written to the switch comprises animating visible content written to the switch.

18. The method of claim 14 wherein changing the appearance of the switch comprises changing the switch color in conjunction with changing visible content written to the switch.
